(19) United States
(12) Patent Application Publication
(10) Pub. No.: US 2019/0014968 A1
(43) Pub. Date: Jan. 17, 2019

(54) SYSTEM FOR REMOTE MONITORING OR CONTROLLING OF WASHERS, LIKE COMMERCIAL DISHWASHERS

(71) Applicant: ILLINOIS TOOL WORKS INC., Glenview, IL (US)

(72) Inventors: Klaus PADTBERG, Offenburg (DE); Sven LEHMANN, Appenweier (DE)

(21) Appl. No.: 16/069,002

(22) PCT Filed: Feb. 1, 2017
(86) PCT No.: PCT/US2017/015934

§ 371 Date: Jul. 10, 2018

(30) Foreign Application Priority Data
Feb. 2, 2016 (DE) 10 2016 101 790.6

(51) Int. Cl. A47L 15/00; A47L 15/42; G05B 19/042; H04W 4/38

(52) U.S. Cl. CPC A47L 15/0063; A47L 15/4202; G05B 19/0428; H04W 4/38; H04L 67/12; A47L 2401/02; A47L 2401/34; G05B 2219/2633; G05B 2219/24015; A47L 2401/12

(57) ABSTRACT

The invention relates to a system, wherein the system has a washer (1) that is preferably in the form of a commercial washer (1). The washer (1) may be in the form of a utensil washer or dishwasher. Further, the system has at least one sensor device for capturing at least one process-relevant parameter of the washer (1) and/or for monitoring at least one function-relevant component of the washer (1). The system additionally has a machine control unit having a device for wireless data transmission for transmitting received sensor data from the sensor device to an external device (2).

The invention relates to a system having a washer, wherein the washer is preferably in the form of a commercial washer. The system further has at least one sensor device.

Known washers have sensors for capturing parameters of the washer. By way of example, the temperature can be captured in order to monitor the progress of a wash program. The sensor data are transmitted, in known washers, to a controller, with evaluation of the sensor data being performed in the controller.

The evaluated sensor data can be presented on a display of the washer, as a result of which an operator of the washer obtains substantial information about the operation of the washer. It is also possible for the evaluated sensor data to be used by the controller in order to control a wash program of the washer. By way of example, a length of the wash program can be varied on the basis of the measured and evaluated sensor data.

Known washers have the disadvantage that an operator needs to be in situ in order to obtain the information that is provided by the controller, since this information is presented on the display of the washer.

Furthermore, the operator needs to perform steps on the basis of the presented information, such as refilling salt, for example. If a spare part is needed, the operator of the washer needs to contact a dealer or the manufacturer of the washer in order to order the spare part. In this case, it is necessary in most cases for trained personnel to examine the washer in order to be able to determine precisely what steps are necessary.

It is therefore an object of the present invention to develop/enhance a known system such that operation and maintenance of the system are optimized.

This object is achieved according to the invention by independent Patent claim 1 of the present invention. Advantageous developments are specified in the dependent claims.

Accordingly, a system is proposed that has a washer. The washer is preferably in the form of a commercial washer. The washer may be in the form of a utensil washer or dishwasher.

The system further has at least one sensor device for capturing at least one process-relevant parameter of the washer and/or for monitoring at least one function-relevant component of the washer. The system furthermore has a machine control unit having a device for wireless data transmission for transmitting received sensor data from the sensor device to an external device, which is not connected to the washer. The machine controller transmits the received sensor data that are transmitted from the sensor device to the machine control unit to the device for wireless data transmission. Subsequently, the device for wireless data transmission transits the sensor data to an external device, the external device being provided separately from the washer, in particular physically separately from the washer.

Process-relevant parameters may be, by way of example, the temperature of the washer or of the treatment zone of the washer. Other process-relevant parameters are, by way of example, the humidity in a treatment zone of the washer, the length of a wash process, the degree of soiling on the items to be washed, etc.

Function-relevant components of the washer may be, by way of example, correctly inserted filters or closed doors.

The washer can be used for washing crockery, but also for washing trays, medical equipment and parts, brushes, plates, pots, pans, etc.

The advantages of the system according to the invention are based on the circumstance that an operator of the washer no longer needs to be directly in situ in order to obtain information about the operation and state of the washer. Rather, an operator can use the Internet, for example, to access the process-relevant parameters and the monitoring of the function-relevant components of the washer. In this case, the operator accesses the information that has been transmitted from the device for wireless data transmission to the external device.

It is also conceivable for the manufacturer to directly obtain information about process-relevant parameters or about function-relevant components of the washers by virtue of the manufacturer accessing the relevant data or information on the external device. As such, a reaction to error reports or missing parts of the washer can take place quickly and purposefully. Furthermore, the washer does not have to have a complex and expensive evaluation device, since the evaluation of the process-relevant parameters and the monitoring of the process-relevant components can be performed on the external device.

Hence, the reaction speed can be improved if an error in the washer is detected, or servicing or maintenance of the washer needs to be performed, or spare parts for the washer need to be made available. It is also possible to speed up the provision of consumables, such as salt or rinse aid, for example. These parts therefore do not need to be stored in large quantities, but rather can be ordered as required.

This allows the standing time of the washer, i.e. the time during which a machine or installation cannot operate, for example during servicing, cleaning or the like, that is to say during which the washer is at a standstill, to be reduced.

According to one aspect of the invention, the external device is in the form of a server. The server is designed such that the sensor data can be transmitted from the device for wireless data transmission to the server via an Internet connection.

This ensures that the external device that is in the form of a server can be provided physically separately from the washer. Furthermore, multiple washers can transmit their measured sensor data to a single server, as a result of which overall complexity and hence costs fall.

Furthermore, this allows evaluation of the measured or captured process-relevant parameters and monitoring of the function-relevant components of the washer to be improved, since the server has superior computation power. An evaluation device that is provided in a manner integrated in the washer has, in contrast thereto, merely limited computation power, since the evaluation device needs to have small dimensions and be provided inexpensively. The server has, in contrast thereto, superior computation power that can be used in order to evaluate the measured sensor data as best possible. As a result, it is also possible for the speed of the evaluation to be improved.

Furthermore, the access to the evaluated sensor data is simplified, since various devices can access the server using known methods. It is thus possible, by way of example, for different terminals, such as laptops or smartphones, for example, to access the server in order to receive the evaluated sensor data.

The access to the sensor data and/or to the evaluated sensor data can be controlled in this case, so that particular groups of people are granted access to the data. Possible groups of people in this case are, by way of example, service employees, the operator/owner of the machine, dealers, etc.

According to a further aspect of the invention, the server is designed to evaluate the sensor data at least in part.

The effect that can be achieved by this is that when the server is accessed, there are already evaluated sensor data available that permit direct interpretation of the state of the washer. As such, a smartphone or a laptop, for example, can be used to access the server, with evaluated sensor data being transmitted to the smartphone or the laptop in this case. A user of the smartphone or of the laptop can therefore tell at a glance whether a reaction to the evaluated sensor data is needed.

It is also possible for the evaluation on the server to be carried out such that the server automatically compares predetermined limit values with the evaluated sensor data in order to determine whether a reaction to the evaluated sensor data is needed. If a reaction to the evaluated sensor data is needed, then the server may be designed to send a notification. Such a notification can, by way of example, be transmitted by email to a smartphone or a laptop of an operator of the washer or laptop of a service employee.

According to a further aspect of the invention, the server is designed to perform temperature evaluation and preferably temperature logging on the basis of the received sensor data.

As a result, it is possible to ascertain whether the temperature in the treatment zone of a washer corresponds to predetermined limit values, or exceeds them. It is also possible for the temperature in the treatment zone of a washer to be monitored over a longer period and hence for a check to be performed to determine whether the temperature in the treatment zone assumes abnormal values or exceeds predetermined limit values during wash processes of the washer.

According to a further aspect of the invention, the server is designed to perform resource use evaluation on the basis of the received sensor data, preferably on the basis of the power draw of the washer.

As a result, it is possible to check whether the resource use of the washer corresponds to predetermined values, or exceeds predetermined limit values.

According to a further aspect of the invention, the server is designed to perform operating cost computation on the basis of the received sensor data. Preferably, the operating cost computation is performed on the basis of the resource use evaluation.

According to a further aspect of the invention, the server takes the received sensor data as a basis for performing error detection and/or fault detection.

As a result, the reaction time for a detected error or a detected fault can be reduced, since, in this case, the server preferably automatically generates and sends an appropriate report to an operator of the washer and/or to the manufacturer of the washer and/or to a dealer.

According to a further aspect of the invention, the server is designed to take the received sensor data as a basis for performing service recommendation detection, and preferably hygiene program detection.

This involves the use, by way of example, of sensor data that indicate the degree of soiling on the items to be washed.

A detected service recommendation or a detected hygiene program can be transmitted to an operator of the washer, so that the latter can start an appropriate program of the washer. Additionally or alternatively, the operator can retrieve hygiene logs for a user-selectable period.

According to a further aspect of the invention, the device for wireless data transmission is in the form of a Bluetooth device or a WLAN device.

As a result, a popular data transmission module can be installed in the washer, which lowers the costs of the device for wireless data transmission.

According to a further aspect of the invention, the external device is designed to transmit the sensor data and/or the at least partially evaluated sensor data to a terminal of an operator of the washer and/or to a terminal of a manufacturer and/or to a terminal of an owner of the washer and/or to a terminal of a dealer. This transmission is effected preferably wirelessly and even more preferably via an Internet connection.

As a result, the sensor data or the at least partially evaluated sensor data are available to the operator of the washer. Alternatively, the sensor data or the at least partially evaluated sensor data are available to the manufacturer of the washer and/or to the owner of the washer and/or to a dealer.

This shortens the reaction time, which indicates how much time elapses between the capture of sensor data in the washer and the appropriate reaction to the captured sensor data, for example in the form of the ordering of a spare part or the starting of a hygiene program.

According to a further aspect of the invention, the external device is in the form of a terminal of the operator of the washer. In this case, the provision of a separate server is dispensed with, and the device for wireless data transmission transmits the sensor data directly to a terminal of the operator, and preferably to a smartphone of the operator.

In this case, there is provision for evaluation of the sensor data to be performed on the smartphone of the operator, or for the sensor data to be transmitted from the smartphone to a further server via an Internet connection. On the further server, it is then possible for the sensor data to be evaluated, the evaluated sensor data subsequently being able to be transmitted to the smartphone or the terminal of the operator of the washer again.

The device for wireless data transmission may therefore be part of a WLAN network or act as a hotspot in order to transmit the sensor data directly to a terminal of the operator. If the device for wireless data transmission is part of a WLAN network, then the data are transmitted from the device for wireless data transmission to an external device, preferably a server.

According to a further aspect of the invention, the terminal of the operator of the washer is in the form of a PC, laptop, smartphone or tablet.

Hence, the operator of the washer can pick up the sensor data or the partially evaluated sensor data in visually optimum fashion. This can involve the use of the display of the terminal, as a result of which it is possible for a large display to be dispensed with for the washer. This in turn reduces costs for the manufacture of the washer.

The terminal, which is preferably in the form of a smartphone, can make quick operating instructions, explaining simple repairs or service operations on the machine, available to the operator directly. It is also conceivable for consumables or spare parts to be able to be re-ordered in a simple manner. Finally, it is conceivable for categorized error reports from the washer to be presented to the operator via the terminal and for said operator to be informed about categorized error reports.

The operator can also use the terminal to view the operating states of all of his machines on a single device. In the event of an error, the operator can reach a defined service partner at a single push of a button. The operator can also identify standstill or peak times for the washer and/or obtain recommendations for more efficient use of the washer.

The sensor data furthermore allow the resource uses to be evaluated on the basis of stored or retrievable costs over a user-selectable period, with water, chemical and energy costs being able to be broken down in this case.

According to a further aspect of the invention, the sensor data can be evaluated on the manufacturer server such that the user behaviour of the operator of the washer and/or faults in the washer and/or error reports from the washer can be detected.

As a result, the manufacturer itself can react as appropriate promptly. Also or alternatively, the manufacturer can transmit appropriate recommendations to the operator of the washer in order to take the user behaviour of the operator as a basis for optimizing the operation of the washer.

According to a further aspect of the invention, the manufacturer server is designed such that the ascertained user behaviour and/or the fault and/or the error report can be taken as a basis for transmitting assistance to the operator of the washer and/or proposing to the operator of the washer the delivery of a spare part and/or delivering a spare part to the operator of the washer.

The assistance allows the operator to react purposefully to the evaluated sensor data without the operator needing to read a complete user manual for the washer. The operator is directed purposefully to the actions that he needs to perform. Superfluous reading or superfluous informing of the operator about the washer is therefore avoided. This signifies a time saving for the operator. Accordingly, the delivery of a spare part can be optimized by virtue of information for ordering the spare part being purposefully transmitted to the user or even the spare part being ordered in automated fashion. Additionally or alternatively, it is conceivable for the operator to be able to request quotations for spare parts.

According to a further aspect of the invention, a program, preferably an app, can be installed on the terminal of the operator such that the program can communicate with the server and/or the manufacturer server and can present data to the operator.

The program is designed such that the operator is presented with all the relevant sensor data and/or all the relevant at least partially evaluated sensor data, so that the operator can quickly grasp whether a reaction is necessary, and if a reaction is necessary, what reaction is appropriate. Preferably, the operator can furthermore directly select the appropriate reaction, whereupon the program transmits an appropriate command to the server, which thereupon transmits this command to the device for wireless data transmission of the washer. The latter then transmits the command to the machine control unit of the washer, whereupon the washer is actuated as appropriate.

According to a further aspect of the invention, the operator can use the program to carry out control of the washer and/or an instruction to rectify errors in the washer, and/or can order spare parts and/or cleaners and/or rinse aids and/or water cartridges by means of the program.

Hence, operation of the washer is substantially facilitated, since the operator of the washer does not need to be in direct proximity to the washer.

According to a further aspect of the invention, the program includes at least one operating instruction and/or an operating instruction can be transmitted from the server and/or the manufacturing server to the program. The operating instruction preferably comprises a description of the process for refilling salt and/or for cleaning the washing arms and/or for inserting the tank cover filter.

Hence, the operator of the washer does not have to bring along further prior knowledge in order to be able to react to the evaluated sensor data of the washer in optimum fashion.

According to one aspect of the invention, the program is designed such that it provides the operator of the washer with statistics pertaining to the resource use of the machine.

As a result, the operator of the washer can best appreciate whether operation of the washer proceeds according to his wishes. If need be, the operator can take the statistics as the basis for modifying use of the washer, so that this use conforms to his wishes. By way of example, it is conceivable for statistics pertaining to the resource use of the machine to be displayed to the operator, whereupon the operator moves use of the washer to the night in order to save costs.

The invention is described in more detail below with reference to the accompanying drawings on the basis of exemplary embodiments of the system according to the invention. dr

### IN THE DRAWINGS

FIG. 1: shows a schematic representation of the system according to the invention, of an external device, of terminals of users of the washer and of a manufacturer server; and

FIG. 2: shows a schematic representation of multiple systems according to the invention, of an external device, of terminals of users of the washers, of dealers and of a manufacturing server.

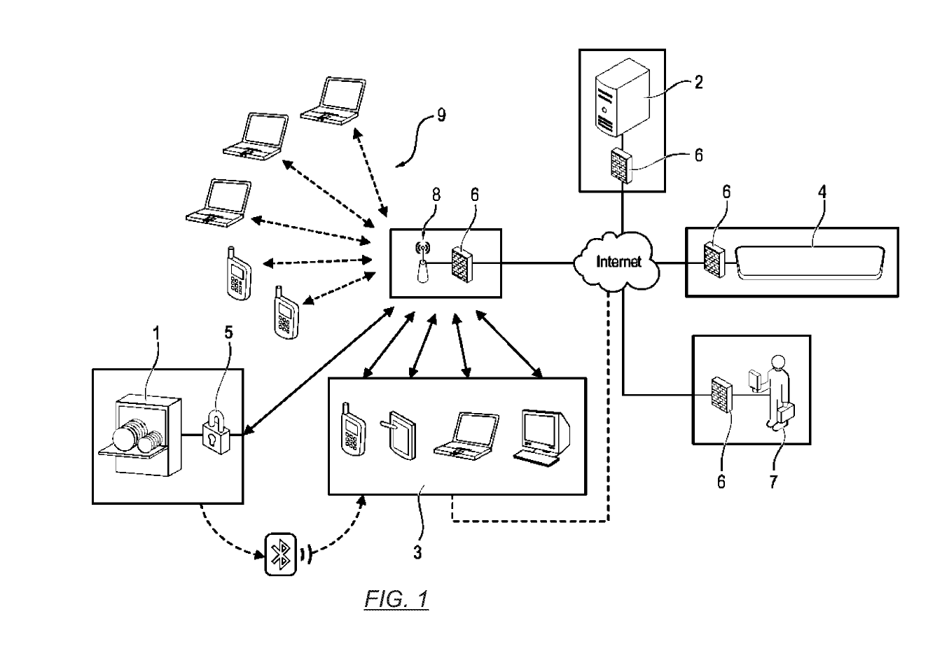

FIG. 1 shows a system, wherein the system is a washer 1.

The washer 1 has at least one sensor device arranged in it, wherein the sensor device measures or captures process-relevant parameters of the washer and furthermore monitors at least one function-relevant component of the washer. To this end, the sensor device preferably has at least one sensor.

The sensor device can have at least one sensor for capturing process-relevant parameters and at least one further sensor for monitoring function-relevant components of the washer 1. It is also possible for a single sensor to be provided for capturing process-relevant parameters and for monitoring function-relevant components of the washer 1.

The sensor is in the form of a temperature sensor, for example. Furthermore, the at least one sensor or the sensor device is not represented in FIG. 1, but rather is provided within the washer 1.

In addition, the washer 1 (not represented in FIG. 1) has a machine control unit that is designed (e.g., configured via software, firmware and/or hardware) to control the washer 1. The machine control unit is in the form of a processor, for example, wherein the machine control unit preferably additionally has a volatile and/or nonvolatile memory.

Finally, the washer 1 has, according to the invention, a device for wireless data transmission. This device is provided in the washer 1 and is preferably provided as part of the machine control unit. The device for wireless data transmission is not shown in FIG. 1.

The at least one sensor generates sensor data that correspond to process-relevant parameters of the washer or are generated from the monitoring of at least one function-relevant component of the washer 1. These sensor data are transmitted from the at least one sensor to the machine control unit of the washer. The machine control unit in turn transmits the sensor data to the device for wireless data transmission.

The device for wireless data transmission transmits the sensor data to an external device 2. The external device 2 is preferably in the form of a server.

The device for wireless data transmission or the washer 1 and the external device (server 2) may have a security device 5, preferably a firewall 6, provided between them.

The security device 5 is designed to prevent unauthorized access to the sensor data of the washer 1.

The external device (server 2) can transmit the sensor data to terminals 3 of users of the washer. The terminals 3 may also be associated with service employees, for example, in order to optimize operation of the washer 1.

The terminals 3 may be in the form of smartphones, tablets or PCs, for example.

The sensor data that are transmitted from the washer 1 to the external device (server 2) can be evaluated in part on the external device (server 2). To this end, the external device (server 2) has a processor and also preferably a volatile and/or nonvolatile memory.

The terminals 3 can have the sensor data and/or the partially evaluated sensor data transmitted to them directly or following evaluation by the external device (server 2).

Furthermore or alternatively, the sensor data and/or the partially evaluated sensor data can be transmitted to a manufacturer server 4 of the manufacturer of the washer.

It is also possible for the sensor data to be transmitted directly from the device for wireless data transmission to a terminal of an operator. In this case, the device for wireless data transmission is preferably provided as a Bluetooth device. The device for wireless data transmission may also be in the form of a WLAN hotspot.

The transmission of the sensor data and/or of the partially evaluated sensor data from the external device (server 2) to the manufacturer server 4 is effected preferably via an Internet connection. The transmission via the Internet 6 is preferably monitored by a further security device 5. The further security device 5 may in turn be in the form of a firewall.

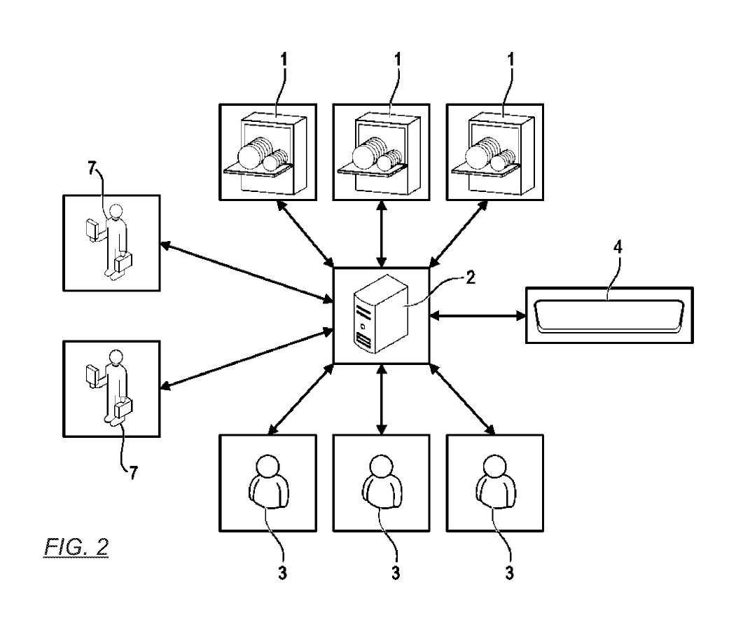

As represented in FIG. 2, it is also possible for multiple washers 1 to transmit their sensor data to a single external device (server 2).

The external device (server 2) can in turn transmit the sensor data directly to terminals 3 and/or a manufacturer server 4 and/or dealer 7.

Additionally or alternatively, the external device (server 2) can evaluate the sensor data at least in part.

The invention is not limited to the embodiments of the system according to the invention that are represented in the drawings, but rather arises from the combination of all of the features disclosed herein.

### LIST OF REFERENCE SYMBOLS

1 Washer

2 External device/server

3 Customer/terminal of the customer

4 Manufacturer/terminal of the manufacturer

5 Security device

6 Firewall

7 Dealer/terminal of the dealer

8 Router/access point

9 Third network subscriber

1-18. (canceled)

19. A system comprising:
a washer in the form of a utensil washer or dishwasher;
a sensor device for capturing at least one process-relevant parameter of the washer and/or for monitoring at least one function-relevant component of the washer;
a machine control unit having a device for wireless data transmission for transmitting received sensor data from the sensor device to an external device.

20. The system according to claim 19, wherein the external device is in the form of a server, and the server is designed such that the sensor data can be transmitted from the device for wireless data transmission to the server via an Internet connection.

21. The system according to claim 20, wherein the server is designed to evaluate the sensor data at least in part.

22. The system according to claim 21, wherein the server is designed to perform temperature evaluation including at least temperature logging on the basis of the received sensor data.

23. The system according to claim 22, wherein the server is designed to perform resource use evaluation on the basis of the received sensor data.

24. The system according to claim 23, wherein the server is designed to perform operating cost computation on the basis of the resource use evaluation.

25. The system according to claim 21, wherein the server is designed to utilize the received sensor data as a basis for performing error detection and/or fault detection.

26. The system according to claim 25, wherein the server is designed to utilize the received sensor data as a basis for performing error detection and to translate an error code into plain text and to make it available to the user.

27. The system according to claim 21, wherein the server is designed to utilize the received sensor data as a basis for performing service recommendation detection.

28. The system according to claim 19, wherein the device for wireless data transmission is in the form of a Bluetooth device or a WLAN device.

29. The system according to claim 19, wherein the external device is embodied as a server that is designed to transmit the sensor data and/or at least partially evaluated sensor data to a terminal of an operator of the washer and/or to a manufacturer and/or operator of the washer and or to a dealer.

30. The system according to claim 29, wherein the terminal of the operator of the washer is in the form of a PC, laptop, smartphone, or tablet.

31. The system according to claim 30, wherein the server or the manufacturer can evaluate the sensor data such that the user behaviour of the operator of the washer (1) and/or faults and/or error reports can be detected.

32. The system according to claim 31, wherein the server and/or a device of the manufacturer that receives the sensor data is designed such that the detected user behaviour and/or the fault and/or the error report can be taken as a basis for transmitting assistance to the operator of the washer and/or proposing to the operator of the washer the delivery of a spare part and/or delivering a spare part to the operator of the washer.

33. The system according to claim 29 wherein an app is installed on the terminal of the operator such that the program can communicate with the server and/or with the manufacturer and can present data to the operator.

34. The system according to claim 33, wherein the program is designed such that the operator can carry out control of the washer and/or an instruction to rectify errors in the washer and/or can order spare parts and/or cleaners and/or rinse aids and/or water cartridges by means of the program.

35. The system according to 34, wherein the program includes at least one operating instruction and/or at least one operating instruction can be transmitted from the server and/or the manufacturer to the program, the at least one operating instruction comprising a description of the process for refilling salt and/or for cleaning the washing arms and/or for inserting the tank cover filter.

36. The system according to claim 35, wherein the program is designed such that it provides the operator of the washer with statistics pertaining to the resource use of the machine.
